(19) United States
(12) Patent Application Publication
(10) Pub. No.: US 2014/0057571 A1
(43) Pub. Date: Feb. 27, 2014

(54) APPARATUS FOR MEASURING RADIATED POWER OF WIRELESS COMMUNICATION DEVICE AND METHOD THEREOF

(71) Applicant: ELECTRONICS AND TELECOMMUNICATIONS RESEARCH INSTITUTE, Daejeon (KR)

(72) Inventors: Soon-Soo OH, Daejeon (KR); Young Hwan LEE, Daejeon (KR); Hyung Do CHOI, Seoul (KR)

(73) Assignee: ELECTRONICS AND TELECOMMUNICATIONS RESEARCH INSTITUTE, Daejeon (KR)

(21) Appl. No.: 13/949,566

(22) Filed: Jul. 24, 2013

(30) Foreign Application Priority Data
Aug. 21, 2012 (KR) 10-2012-0091502

(51) Int. Cl. H04B 17/00

(52) U.S. Cl. CPC H04B 17/0032
USPC 455/67.11

(57) ABSTRACT

Disclosed are an apparatus for measuring radiated power and a method thereof. The apparatus for measuring radiated power includes: a measurement unit configured to receive an RF signal radiated from an antenna of the wireless communication device to generate a radiated power measurement value; a driving unit configured to vertically ascend or descend the measurement unit from the ground; and an operation control unit configured to control the driving unit to ascend the measurement unit to a point at which the antenna is installed and convert the radiated power measurement value into a measurement value on a target point. In accordance with the embodiment of the present invention, even when the antenna of the wireless communication device is inclined to the ground, the radiated power of the wireless communication device can be accurately measured by compensating for the change in the measurement distance due to the inclined angle.

### CROSS-REFERENCES TO RELATED APPLICATIONS

The present application claims priority under 35 U. S. C 119(a) to Korean Application No. 10-2012-0091502, filed on August 21, 2012, in the Korean Intellectual Property Office, which is incorporated herein by reference in its entirety set forth in full.

### BACKGROUND

Exemplary embodiments of the present invention relate to an apparatus for measuring radiated power of a wireless communication device an a method thereof, and more particularly, to an apparatus for measuring radiated power of a wireless communication device capable of accurately measuring radiated power of a wireless communication device that is several meters to several tens of meters above the ground.

Generally, an example of a method for measuring radiation characteristics of an antenna may include a far-field measuring method, a near-field measuring method, Fresnel-field measuring method, and the like.

The far-field measuring method can obtain a desired value by one-time scanning, but has a limitation in spacing a distance between an antenna of a wireless communication device and a measuring apparatus as much as far-field conditions.

When a diameter of an aperture of an antenna is represented by D and a wavelength of a measuring frequency is represented by λ, a diameter meeting the far-field conditions may be represented by the following Equation 1.

$$R = \frac{{D}^{2}}{λ} \qquad [ Equation 1 ]$$

For example, in order to meet the far-field conditions of a repeater antenna having a diameter of 2 [m] that transmits a frequency signal of 800 [MHz], a distance of 22 [m] or more needs to be secured.

However, since several obstacles such as artificial structures, natural objects, and the like, are present around base stations or repeaters that are installed in the open field, when the antenna is spaced apart from the measuring apparatus as much as the far-field conditions, multi-reflected waves occur, such that it is difficult to accurately measure the radiated power.

Therefore, as an alternative plan, the near-field measuring method and the Fresnel-field measuring method are used.

The near-field measuring method and the Fresnel-field measuring method perform the measurement at a closer distance than the far-field measuring method and therefore, can remove the multi-reflected waves. However, a process of converting measurement values obtained at several points into a far field is required.

Further, in order to obtain a plurality of measurement values, there is a need to perform measurement on a line or a plane at a predetermined distance from an antenna aperture of a wireless communication device.

Generally, since the antenna of the wireless communication device is inclined to the ground, when performing the measurement by vertically ascending the measuring apparatus, the distance between the antenna and the measuring apparatus may be constantly maintained.

As the related art, there is Korean Laid-Open Publication No. 10-2007-0101093 (Publication on Oct. 16, 2007, entitled “System And Method For Measurement Of Antenna Radiation Pattern In Fresnel Region).

The above-mentioned technical configuration is a background art for helping understanding of the present invention and does not mean related arts well known in a technical field to which the present invention pertains.

### SUMMARY

An embodiment of the present invention is directed to an apparatus for measuring radiated power of a wireless communication device and a method thereof capable of accurately measuring radiated power of a wireless communication device that is several meters to several tens of meters above the ground.

An embodiment of the present invention relates to an apparatus for measuring radiated power of a wireless communication device, including: a measurement unit configured to receive an RF signal radiated from an antenna of the wireless communication device to generate a radiated power measurement value; a driving unit configured to vertically ascend or descend the measurement unit from the ground; and an operation control unit configured to control the driving unit to ascend the measurement unit to a point at which the antenna is installed and convert the radiated power measurement value input from the measurement unit into a measurement value on a target point.

The operation control unit may convert the radiated power measurement value into the measurement value on the target point using a measurement distance between the antenna and a measuring point and a target distance between the antenna and the target point.

The operation control unit may convert the radiated power measurement value into the measurement value on the target point using a value obtained by integrating, in respect to coordinates on the antenna, a combined Equation of the measurement distance, the target distance, and the phase coefficient of the RF signal.

The measurement unit may include: a measuring antenna configured to receive a horizontal component signal and a vertical component signal of the RF signal; a distance measuring sensor configured to measure a horizontal distance from the antenna and a height above the ground; and a measuring control unit configured to generate the radiated power measurement value from the RF signal and transmit the radiated power measurement value, the distance from the antenna, and the height above the ground to the operation control unit.

The measuring antenna may be configured of a frequency variable antenna.

The operation control unit may calculate an inclined angle of the antenna based on a change in the distance from the antenna input from the measurement unit.

The measuring unit may further include: a camera configured to photograph the antenna to generate an image signal.

Another embodiment of the present invention relates to a method for measuring radiated power of a wireless communication device, including: controlling, by an operation control unit, to control a driving unit to ascend a measuring unit to a point at which an antenna of the wireless communication device is installed; receiving, by the operation control unit, a radiated power measurement value of the antenna from the measuring unit; and converting, by the operation control unit, the radiated power measurement value into a measurement value on a target point.

In the converting of the radiated power measurement value into the measurement value on the target point, the operation control unit may convert the radiated power measurement value into the measurement value on the target point using a measurement distance between the antenna and a measuring point and a target distance between the antenna and the target point.

The operation control unit may convert the radiated power measurement value into the measurement value on the target point using a value obtained by integrating, in respect to coordinates on the antenna, a combined Equation of the measurement distance, the target distance, and the phase coefficient of the RF signal.

The method for measuring radiated power of a wireless communication device may further include: operating, by the operation control unit, far-field radiated power based on the measurement value on the target point.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram schematically illustrating a structure of an apparatus for measuring radiated power of a wireless communication device in accordance with an embodiment of the present invention;

FIG. 2 is a block diagram illustrating a configuration of the apparatus for measuring radiated power of a wireless communication device in accordance with the embodiment of the present invention;

FIG. 3 is a diagram for describing a process of converting a radiated power measurement value into a measurement value on a target point in the apparatus for measuring radiated power of the wireless communication device in accordance with the embodiment of the present invention;

FIG. 4 is a first block diagram illustrating a configuration in which a measurement unit is included in the apparatus for measuring radiated power of a wireless communication device in accordance with the embodiment of the present invention;

FIG. 5 is a second block diagram illustrating a configuration in which a measurement unit is included in the apparatus for measuring radiated power of a wireless communication device in accordance with the embodiment of the present invention; and

FIG. 6 is a flow chart illustrating an operation of a method for measuring radiated power of a wireless communication device in accordance with the embodiment of the present invention.

### DESCRIPTION OF SPECIFIC EMBODIMENTS

Hereinafter, an apparatus for measuring radiated power of a wireless communication device in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

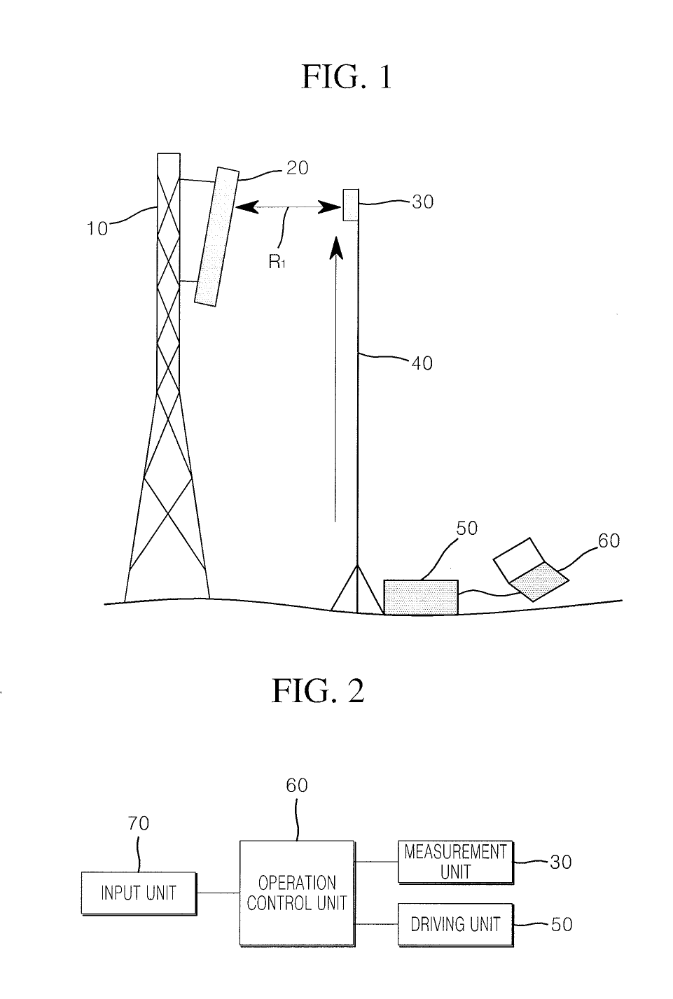

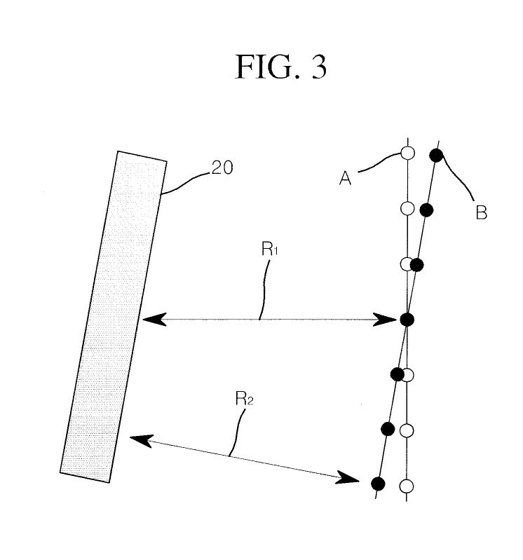

FIG. 1 is a diagram schematically illustrating a structure of an apparatus for measuring radiated power of a wireless communication device in accordance with an embodiment of the present invention, FIG. 2 is a block diagram illustrating a configuration of the apparatus for measuring radiated power of a wireless communication device in accordance with the embodiment of the present invention, and FIG. 3 is a diagram for describing a process of converting a radiated power measurement value into a measurement value on a target point in the apparatus for measuring radiated power of the wireless communication device in accordance with the embodiment of the present invention.

As illustrated in FIGS. 1 and 2, an apparatus for measuring radiated power of a wireless communication device in accordance with an embodiment of the present invention includes a measurement unit 30, an elevating unit 40, a driving unit 50, an operation control unit 60, and an input unit 70.

The measurement unit 30 measures radiated power radiated from the antenna 20 of the wireless communication device to generate a radiated power measurement value and transmit the generated measurement value to the operation control unit 60.

As illustrated in FIG. 1, wireless communication devices, such as base stations, repeaters, and the like, that are installed in the open field are generally installed at artificial structures 10, such as a steel tower, a telephone post, walls of a building, and the like, the installation height thereof reaches several meters to several tens of meters.

Therefore, the measurement unit 30 ascends up to a height at which the antenna 20 of the wireless communication device is installed to measure the radiated power of the antenna 20. That is, as illustrated in FIG. 1, the measurement unit 30 measuring the radiated power of the antenna at a plurality of points by vertically ascending or descending from the ground.

In this case, the measurement unit 30 performs the measurement at points spaced apart from the antenna 20 by a measurement distance R₁. The measuring point is an area corresponding to the near field or the Fresnel field and is at relatively close points to the antenna 20.

As such, the near-field radiated power is measured at a point close to the antenna 20 of the wireless communication antenna 20, thereby remove the effect due to the multi-reflected waves.

The elevating unit 40 ascends or descends while supporting the measurement unit 30 and is driven by the driving unit 50. The elevating unit 40 may be implemented in various forms, which can elevate the measurement unit 30.

For example, the measurement unit 30 is fixed to the elevating unit 40 such that the measurement unit 30 may be elevated according to the elevation of the elevating unit 40 and when the elevating unit 40 ascends up to a predetermined height, the measurement unit 30 may be independently elevated along the elevating unit 40.

The driving unit 50 drives the elevating unit 40 to ascend or descend the measurement unit 30 and an operation thereof is controlled by the operation control unit 60. The driving unit 50 may be implemented as a motor (not illustrated) that transfers a driving force to the elevating unit 40.

The input unit 70 receives a driving signal for ascending or descending the measurement unit 30 and a signal for measuring radiated power from a user and transfers the signals to the operation control unit 60.

The operation control unit 60 controls the driving unit 50 when the driving signal is input from the input unit 70 to ascend the measurement unit 30 to a point at which the antenna 20 is installed and when the measuring signal is input from the input unit 70, consecutively receives the radiated power measurement value from the measurement unit 30.

Next, the operation control unit 60 converts the radiated power measurement value input from the measurement unit 30 into the measurement value on the target point and operates far-field radiated power based on the converted measurement value.

Most users using communication services are present on the ground, such that the antenna 20 of the wireless communication device may be generally installed to face a ground. Further, in the wireless communication device communicating with an airplane or a satellite, the antenna 20 is installed to face up.

That is, as illustrated in FIG. 1, the antenna 20 may be generally inclined to the ground at a predetermined angle.

As such, the antenna 20 is inclined to the ground at a predetermined angle, while the measurement unit 30 vertically ascends or descends from the ground, such that the measurement distance R₁ between the antenna 20 and the measurement unit 30 is changed.

That is, as illustrated in FIG. 3, the measurement unit 30 performs the measurement on a measuring point A, such that the measurement distance R₁ between the antenna 20 and the measurement unit 30 is constantly maintained.

However, when the measurement value at the near field or the Fresnel field is converted into the far field, the measurement distance R₁ between the antenna 20 and the measurement unit 30 needs to be constantly maintained.

That is, when the radiated power measurement value measured by the measurement unit 30 is used as it is, the far-field radiated power cannot be accurately operated.

Therefore, the operation control unit 60 converts the radiated power measurement value measured on the measuring point A into the radiated power measurement value on a target point B to compensate for the change in the measurement distance R₁ due to the inclined angle of the antenna 20.

That is, the radiated power measurement value based on the measurement distance R₁ is converted into the radiated power measurement value based on a target distance R₂.

By the above operation, even when the antenna 20 of the wireless communication device is inclined to the ground, the change in the measurement distance R₁ due to the inclined angle of the antenna 20 may be compensated and as a result, the radiated power can be accurately measured.

In detail, the operation control unit 60 may convert a radiated power measurement value E_{R1} on the measuring point A into a radiated power measurement value E_{R2} on the target point B depending on the following Equation 1.

$${E}_{R 2} = {E}_{R 1} + \{ \frac{- z}{4 π} {\int }_{{x}^{′}} {\int }_{{y}^{′}} ( \begin{matrix}\frac{( 1 + j {kR}_{2} ) {e}^{- j {kR}_{2}}}{{R}_{2}^{3}} - \\ \frac{( 1 + j {kR}_{1} ) {{e}^{- j {kR}_{1}}}^{{ }_{\\}}}{{R}_{1}^{3}}\end{matrix} ) d {x}^{′} d {y}^{′} \} \qquad [ Equation 2 ]$$

In the above Equation 2, x′ and y′ represent coordinates on the antenna 20 that intends to measure the radiated power, R₁ represents the measurement distance between the measuring point A and the coordinates x′ and y′ on the antenna 20, and R₂ represents the target distance between the target point B and the coordinates x′ and y′ on the antenna 20. Further, k, which is a phase coefficient of an RF signal, corresponds to 2 π/λ (wavelength).

That is, the operation control unit 60 may compensate for the radiated power measurement value E_{R1} using value obtained by integrating, in respect to the coordinates on the antenna 20, a combined Equation of the measurement distance R₁ between the antenna 20 and the measuring point A, the target distance R₂ between the antenna 20 and the target point B, and the phase coefficient of the RF signal, such that the radiated power measurement value E_{R2} on the target point B can be accurately operated.

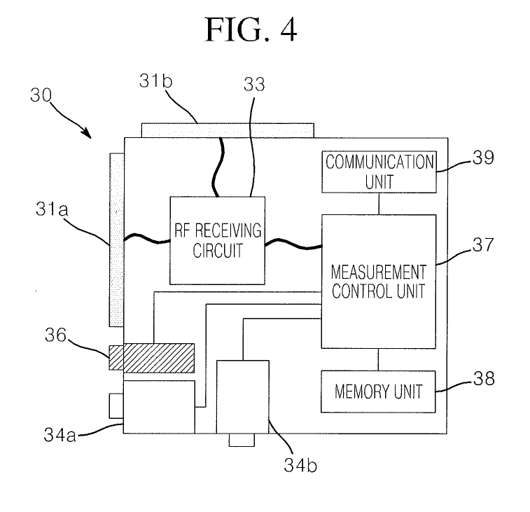

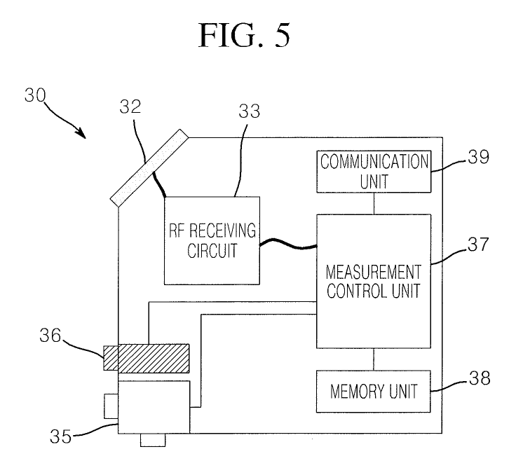

FIG. 4 is a first block diagram illustrating a configuration in which a measurement unit is included in the apparatus for measuring radiated power of a wireless communication device in accordance with the embodiment of the present invention and FIG. 5 is a second block diagram illustrating a configuration in which a measurement unit is included in the apparatus for measuring radiated power of a wireless communication device in accordance with the embodiment of the present invention.

As illustrated in FIG. 4, the measurement unit 30 included in the apparatus for measuring radiated power of the wireless communication device in accordance with the embodiment of the present invention may include a first measuring antenna 31a, a second measuring antenna 31b, an RF receiving circuit 33, a first distance measuring sensor 34a, a second distance measuring sensor 34b, a camera 36, a measurement control unit 37, a memory unit 38, and a communication unit 39.

The first measuring antenna 31a receives an RF signal of a horizontal component, a second measuring antenna 31b receives an RF signal of a vertical component, wherein the RF signals received by the first and second measuring antennas 31a and 31b are transferred to the measurement control unit 37 via the RF receiving circuit 33.

The first distance measuring sensor 34a measures a horizontal distance to the antenna 20 and transfers the measured horizontal distance to the measurement control unit 37 and the second distance measuring sensor 34b measures a height above the ground and transfers the measured height to the measurement control unit 37.

The first and second distance measuring sensors 34a and 34b may be implemented as various sensors, such as a laser sensor, an ultrasonic sensor, and the like, that may measure a distance from a target.

The camera 36 photographs the antenna 20 to generate an image signal, which is in turn transferred to the measurement control unit 37.

The measurement control unit 37 generates the radiated power measurement value from the RF signal input from the RF receiving circuit 33 when the measuring signal is input from the operation control unit 60 via the communication unit 39.

Next, the measurement control unit 37 is transmitted the radiated power measurement value to the operation control unit 60 via the communication unit 39, together with the horizontal distance from the antenna that is input from the first and second distance measuring sensors 34a and 34b and the height above the ground. Further, the measurement control unit 37 may transmit the image signal input from the camera 36.

In this case, the communication unit 39 may transmit data to the operation control unit 60 via wireless communication networks, such as a 3G or 4G mobile communication network, a wireless LAN (Wi-Fi), WiBro, Bluetooth, ZigBee, and the like.

As described above, the operation control unit 60 converts the radiated power measurement value input from the measurement unit 30 into the radiated power measurement value on the target point using the horizontal distance from the antenna 20 and the height above the ground. In this case, the operation control unit 60 may calculate the inclined angle to the antenna 20 based on the change in the horizontal distance from the antenna 20.

Meanwhile, the measurement control unit 37 may store the radiated power measurement value, the distance from the antenna 20, the height above the ground, and the image signal in the memory unit 38.

As such, the measuring antennas 31a and 31b, the distance measuring sensors 34a and 34b, the memory unit 38, and the communication unit 39 are embedded in the measurement unit 30, such that the radiated power of the wireless communication device that is several meters to several tens of meters above the ground can be accurately received without the separate measurement instrument or cable.

Further, the camera 36 uses the image signal obtained by photographing the antenna 20 to monitor the state and measured situations of the antenna 20 of the wireless communication device.

Meanwhile, the measurement unit 30 ascends up to the antenna 20 of the wireless communication device that is several meters to several tens of meters above the ground and therefore, may be formed of a light weight construction.

Therefore, as illustrated in FIG. 5, the measurement unit 30 includes the measuring antenna 32 that can receive the RF signals of the horizontal component and the vertical component, instead of the first and second measuring antennas 31a and 31b, such that the measurement unit 30 of FIG. 4 may be more lightweight.

In this case, the measuring antenna 32 and the RF receiving circuit 33 are each implemented as a frequency variable antenna and a frequency variable RF receiving circuit and therefore, may be configured to receive only the RF signal in a frequency band to be measured.

Further, the measurement unit 30 includes the distance measuring sensor 35 that may simultaneously measure the distance from the antenna 20 and the height above the ground, instead of the first and second distance measuring sensors 34a and 34b, such that the measurement unit 30 of FIG. 4 may be more lightweight.

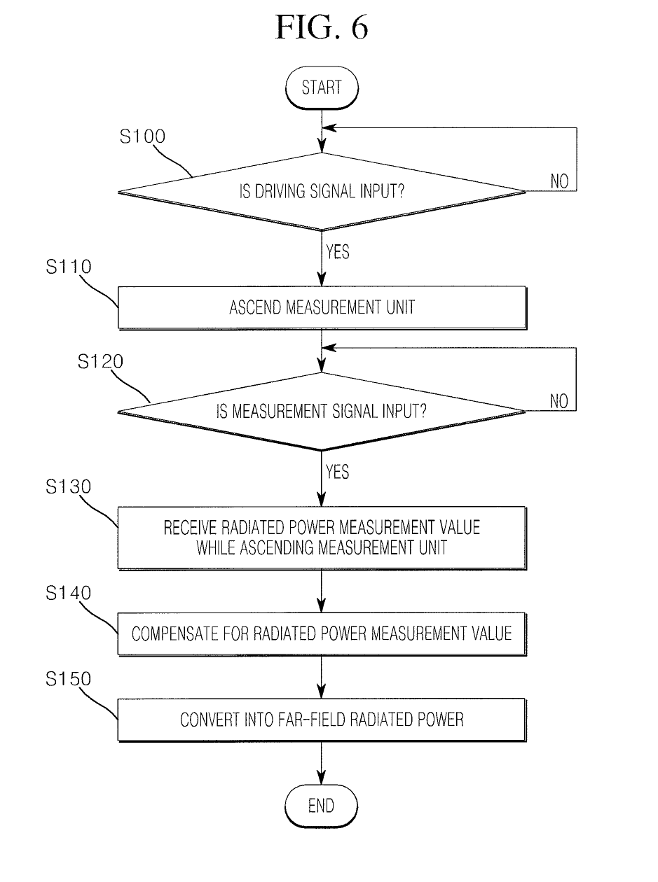

FIG. 6 is a flow chart illustrating an operation of a method for measuring radiated power of a wireless communication device in accordance with the embodiment of the present invention.

As illustrated in FIG. 6, the operation control unit 60 first checks whether the driving signal is input from the input unit 70 (S100).

When the driving signal is input from the input unit 70, the operation control unit 60 controls the driving unit 50 to ascend the measurement unit 30 to a point at which the antenna 20 is installed (S110).

Next, the operation control unit 60 checks whether the measuring signal is input from the input unit 70 (S120) to control the driving unit 50 when the measuring signal is input, such that the operation control unit 60 consecutively receives the radiated power measurement value from the measurement unit 30 while ascending the measurement unit 30 (S130). In detail, the operation control unit 60 receives the radiated power measurement value for a plurality of points from the measurement control unit 37 of the measurement unit 30 via the communication unit 39.

Next, when the measurement of the radiated power is completed, the operation control unit 60 converts the radiated power measurement value input from the measurement unit 30 into the measurement value on the target point B to compensate for the change in the measurement distance R₁ due to the inclined angle of the antenna 20 (S140).

In this case, the operation control unit 60 may convert the radiated power measurement value E_{R1} on the measuring point A into the radiated power measurement value on the target point B depending on the following Equation 1.

Next, the operation control unit 60 converts the radiated power measurement value on the target point B into the far-field radiated power (S150).

By the above operation, even when the antenna 20 of the wireless communication device is inclined to the ground, the change in the measurement distance R₁ due to the inclined angle of the antenna 20 may be compensated and as a result, the radiated power can be accurately measured.

In accordance with the embodiments of the present invention, the far-field radiated power is operated by measuring the near-field radiated power at points near the antenna of the wireless communication device, there by removing an effect due to the multi-reflected waves.

Further, in accordance with the embodiments of the present invention, even when the antenna of the wireless communication device is inclined to the ground, the radiated power measurement value is converted into the measurement value on a target point parallel with the antenna to compensate for the change in the measurement distance due to the inclined angle, thereby accurately measuring the radiated power.

In addition, in accordance with the embodiment of the present invention, the measuring antenna, the distance measuring sensor, the memory, and the communication module are embedded in the measuring apparatus, thereby accurately measuring the radiated power of the wireless communication device that is several meters to several tens of meters above the ground without the separate measurement instrument or cable.

Although the embodiments of the present invention have been described in detail, they are only examples. It will be appreciated by those skilled in the art that various modifications and equivalent other embodiments are possible from the present invention. Therefore, the technical protection scope of the present invention should be defined by the appended claims.

What is claimed is:

1. An apparatus for measuring radiated power of a wireless communication device, comprising:
a measurement unit configured to receive an RF signal radiated from an antenna of the wireless communication device to generate a radiated power measurement value;
a driving unit configured to vertically ascend or descend the measurement unit from the ground; and
an operation control unit configured to control the driving unit to ascend the measurement unit to a point at which the antenna is installed and convert the radiated power measurement value input from the measurement unit into a measurement value on a target point.

2. The apparatus of claim 1, wherein the operation control unit converts the radiated power measurement value into the measurement value on the target point using a measurement distance between the antenna and a measuring point and a target distance between the antenna and the target point.

3. The apparatus of claim 2, wherein the operation control unit converts the radiated power measurement value into the measurement value on the target point using a value obtained by integrating, in respect to coordinates on the antenna, a combined Equation of the measurement distance, the target distance, and the phase coefficient of the RF signal.

4. The apparatus of claim 1, wherein the measurement unit includes:
a measuring antenna configured to receive a horizontal component signal and a vertical component signal of the RF signal;
a distance measuring sensor configured to measure a horizontal distance from the antenna and a height above the ground; and
a measurement control unit configured to generate the radiated power measurement value from the RF signal and transmit the radiated power measurement value, the distance from the antenna, and the height above the ground to the operation control unit.

5. The apparatus of claim 4, wherein the measuring antenna is configured of a frequency variable antenna.

6. The apparatus of claim 4, wherein the operation control unit calculates an inclined angle of the antenna based on a change in the distance from the antenna input from the measurement unit.

7. The apparatus of claim 4, wherein the measurement unit further includes:
a camera configured to photograph the antenna to generate an image signal.

8. A method for measuring radiated power of a wireless communication device, comprising:
controlling, by an operation control unit, to control a driving unit to ascend a measurement unit to a point at which an antenna of the wireless communication device is installed;
receiving, by the operation control unit, a radiated power measurement value of the antenna from the measurement unit; and
converting, by the operation control unit, the radiated power measurement value into a measurement value on a target point.

9. The method of claim 8, wherein in the converting of the radiated power measurement value into the measurement value on the target point, the operation control unit converts the radiated power measurement value into the measurement value on the target point using a measurement distance between the antenna and a measuring point and a target distance between the antenna and the target point.

10. The method of claim 9, wherein the operation control unit converts the radiated power measurement value into the measurement value on the target point using a value obtained by integrating, in respect to coordinates on the antenna, a combined Equation of the measurement distance, the target distance, and the phase coefficient of the RF signal.

11. The method of claim 8, further comprising:
operating, by the operation control unit, far-field radiated power based on the measurement value on the target point.
